(19) United States
(12) Patent Application Publication
(10) Pub. No.: US 2026/0204249 A1
(43) Pub. Date: Jul. 16, 2026

(54) Ambisonic Spatial Reverb Controller

(71) Applicant: Shure Acquisition Holdings, Inc., Niles, IL (US)

(72) Inventor: William Wallace Taylor, III, Gurnee, IL (US)

(21) Appl. No.: 19/389,672

(22) Filed: Nov. 14, 2025

Related U.S. Application Data
(60) Provisional application No. 63/723,657, filed on Nov. 22, 2024.

(51) Int. Cl. G10K 15/08

(52) U.S. Cl. CPC G10K 15/08

(57) ABSTRACT

Methods and apparatuses for augmenting or isolating reverberation effects in an ambisonic audio signal are described. An example apparatus may utilize an ambisonic microphone to capture an ambisonic impulse response of a physical space. The ambisonic impulse response may include a plurality of impulse response channels, which may be convolved with the channels of an ambisonic or monophonic audio signal to add the reverberation effects of the physical space to the audio signal. The apparatus may receive spatial augmentation parameters that may be applied to ambisonic impulse response to augment or isolate certain aspects of the reverberation effects in specific directions of the periphonic sound field.

### CROSS-REFERENCE TO RELATED APPLICATIONS

This application claims priority benefit to U.S. Provisional Patent Application No. 63/723,657, filed Nov. 22, 2024, the entire content of which is hereby incorporated by reference in its entirety and for all purposes.

### FIELD

Aspects described herein generally relate to ambisonic sound effects and/or hardware and/or software related thereto. More specifically, one or more aspects described herein provide for encoding and manipulation of reverberation characteristics of a physical space in an ambisonic audio signal.

### BACKGROUND

Ambisonic audio may refer to a full-sphere periphony used in many virtual reality and/or other immersive applications. For example, ambisonic audio may be encoded according to Ambisonic B-format, which may have four channels labeled W, X, Y, and Z. The W channel corresponds to the mono output from an omnidirectional microphone, while the X, Y, and Z channels correspond to directional components of the sound signal. In other examples, ambisonic audio may include higher-order channels, such as R, S, T, U, V, K, L, M, N, O, P, and Q channels, each including different combinations of sensitivity patterns in the X, Y, and Z directions. With the rising popularity of various services and applications utilizing ambisonic audio, there is an increasing demand for improvements in ambisonic sound effects that can be achieved with relatively simple processes and relatively low-cost equipment.

### SUMMARY

The following presents a simplified summary of the disclosure to provide a basic understanding of some aspects of the disclosure. This summary is not an extensive overview of the disclosure. It is not intended to identify key or critical elements of the invention or to delineate the scope of the invention. The following summary merely presents some concepts of the disclosure in a simplified form as a prelude to the more detailed description provided below.

Capturing ambisonic audio often requires extensive capital, cabling, external companion equipment, and advanced knowledge of A-format to B-format conversion techniques to attain a high-quality ambisonic audio signal. However, depending on the application, a user might not have sufficient time, knowledge, and/or equipment to capture ambisonic audio to attain the desired audio quality properly. Moreover, even if adequate quality ambisonic audio is obtained, the availability of equipment and data models for applying acoustical effects, such as adding or manipulating reverberation effects, may be limited.

As described in more detail herein, methods and apparatuses are set forth for augmenting or isolating reverberation effects in an ambisonic audio signal. An example apparatus may utilize an ambisonic microphone to capture an ambisonic impulse response of a physical space. The ambisonic impulse response may include a plurality of impulse response channels, which may be convolved with the channels of an ambisonic audio signal to add the reverberation effects of the physical space to the audio signal, or convolved with a non-ambisonic audio signal to impose the reverberation and spatial effects of the physical space. The apparatus may receive spatial augmentation parameters that may be applied to ambisonic impulse response to augment or isolate certain aspects of the reverberation effects in specific directions of the periphonic sound field.

An example apparatus may include a processor and one or more memories having computer-executable instructions stored therein that, when executed by the processor, cause the apparatus to perform specific steps. The steps, whether performed by the apparatus or performed as a separate method by another device, may include receiving an ambisonic impulse response, wherein the ambisonic impulse response includes a plurality of impulse response channels corresponding to a plurality of audio channels of an ambisonic audio signal, respectively; receiving an augmentation direction and an augmentation parameter; selecting, based on the augmentation direction, a subset of the plurality of impulse response channels; and augmenting, based on the augmentation parameter, the subset of the plurality of impulse response channels to generate a modified ambisonic impulse response. The steps may further include filtering the ambisonic audio signal with the modified ambisonic impulse response to generate an augmented ambisonic audio signal having augmented reverberation effects and storing the augmented ambisonic audio signal with the augmented reverberation effects in memory. The filtering may include convolving the plurality of audio channels with the corresponding plurality of impulse response channels of the modified ambisonic impulse response, respectively. The steps may also include selecting a second subset of the plurality of impulse response channels not in the subset and attenuating, based on the augmentation parameter, each impulse response channel of the second subset.

In some examples, the augmentation parameter includes a focus level corresponding to an impulse response amplitude adjustment. Augmenting of the subset of channels may include increasing, based on the focus level, a relative peak amplitude or a wet/dry percentage of each impulse response channel of the subset. The steps could also include decreasing, based on the focus level, the relative peak amplitude or the wet/dry percentage of one or more impulse response channels of the plurality of impulse response channels not in the subset.

In some examples, the augmentation parameter includes a perception level corresponding to an impulse response duration adjustment. Augmenting of the subset of channels may include increasing, based on the perception level, a pre-delay or a tail length of each impulse response channel of the subset. The steps could also include decreasing, based on the perception level, the pre-delay or the tail length of one or more impulse response channels of the plurality of impulse response channels not in the subset.

In some examples, the steps include receiving a monophonic audio signal and a steered direction and mapping, based on the steered direction, the monophonic audio signal to the plurality of audio channels to generate the ambisonic audio signal. In some examples, the augmented ambisonic audio signal is converted back to an augmented monophonic audio signal with the augmented reverberation effects scaled according to the steered direction.

Further examples include an ambisonic audio system that includes a user input interface circuit, a processor, and one or more memories stored therein computer-executable instructions that, when executed by the processor, cause the processor to perform specific steps. The steps, whether performed by the ambisonic audio system or separately as a method by another device, may include retrieving, from memory, an ambisonic impulse response that may include X, Y, Z, and W impulse response channels. The steps may further include receiving, via the user input interface circuit, an augmentation parameter and a first subset of channels selected from the X, Y, and Z impulse response channels; designating, as a second subset of channels, the X, Y, and Z impulse response channels that are not in the first subset of channels; modifying the ambisonic impulse response by, augmenting the first subset of channels based on the augmentation parameter, and attenuating the second subset of channels based on the augmentation parameter. The modified ambisonic impulse response may be stored in one or more memories. The steps may further include adjusting, based on a focus level in the augmentation parameter, a relative peak amplitude and a wet/dry percentage of the first subset of channels and the second subset of channels or adjusting, based on a perception level in the augmentation parameter, a pre-delay or a tail length of the first subset of channels and the second subset of channels.

These, as well as other novel advantages, details, examples, features, and objects of the present disclosure, will be apparent to those skilled in the art from following the detailed description, the attached claims, and accompanying drawings listed herein, which are useful in explaining the concepts discussed herein.

### BRIEF DESCRIPTION OF THE DRAWINGS

Some features are shown by way of example, and not by limitation, in the accompanying drawings. In the drawings, like numerals reference similar elements.

FIG. 1 shows an example arrangement for capturing an ambisonic impulse response of a unique physical space according to illustrative aspects described herein.

FIGS. 2A-2D show perspective views of example ambisonic microphones that may be used to implement one or more illustrative aspects described herein.

FIG. 3 shows an example system architecture that may be used to implement one or more illustrative aspects described herein.

FIG. 4 shows an example flowchart of a method for capturing an ambisonic reverberation signal of a physical space according to illustrative aspects described herein.

FIG. 5 shows example block diagrams of applying ambisonic reverberation effects to audio signals according to illustrative aspects described herein.

FIGS. 6A-6E show example impulse responses of an audio signal according to illustrative aspects described herein.

FIGS. 7A-7D show example methods for manipulating an ambisonic reverberation signal according to illustrative aspects described herein.

FIGS. 8A-8F show example graphical user interfaces for manipulating an ambisonic reverberation signal according to illustrative aspects described herein.

FIG. 9 shows an example system architecture that may be used to implement one or more illustrative aspects described herein.

### DETAILED DESCRIPTION

In the following description of the various examples, reference is made to the accompanying drawings, which form a part hereof and are shown, by way of illustration, various examples in which aspects may be practiced. References to “embodiment,” “example,” and the like indicate that the embodiment(s) or example(s) of the invention so described may include particular features, structures, or characteristics, but not every embodiment or example necessarily includes the particular features, structures, or characteristics. Further, it is contemplated that certain embodiments or examples may have some, all, or none of the features described for other examples. It is to be understood that other embodiments and examples may be utilized, and structural and functional modifications may be made without departing from the scope of the present disclosure.

Unless otherwise specified, serial adjectives, such as “first,” “second,” “third,” and the like, that are used to describe components are used only to indicate different components, which can be similar components. However, using such serial adjectives does not imply that the components must be provided in a given order, either temporally, spatially, in ranking, or in any other way, unless otherwise specified.

Also, while the terms “front,” “back,” “side,” and the like may be used in this specification to describe various example features and elements, these terms are used herein as a matter of convenience, for example, based on the example orientations shown in the figures and/or the orientations in typical use. Nothing in this specification should be construed as requiring a specific three-dimensional or spatial orientation of structures to fall within the scope of the claims.

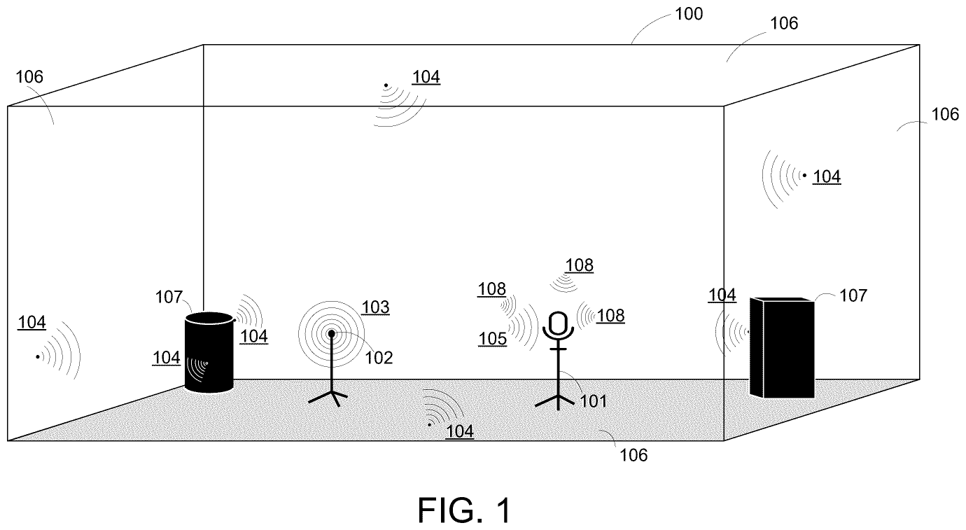

FIG. 1 illustrates a physical space 100 (e.g., a room, lecture hall, church, music venue) where sound may be generated and recorded. Walls, ceiling, and floor may entirely or partially enclose the space, or other structures 106, may contain objects 107, and/or have an atmosphere (e.g., a humidity level), all of which affect the sound characteristics of the space. For example, a sound source 102 (e.g., a speaker, person's voice, horn, musical instrument, etc.) may emit sounds 103 that radiate as waves from the source and through the space (e.g., through the atmosphere in the space) to a receiver 101 (e.g., a person or microphone). As the sound waves travel, they interact with structures 106 and objects 107, which define the physical characteristics of the space. For example, the walls or other structures and objects may absorb certain portions of the sound waves while reflecting other portions that radiate from the structures and objects as reflected waves 104. The sound waves that arrive at receiver 101 are a mix of direct sound waves 105 that travel directly from source 102 to receiver 101 and reverberated sound waves 108 from multiple directions resulting from the reflected sound waves 104. The direct sound waves 105 and reverberated sound waves 108 may be copies of the original sound 103 with changes to the sound's directional, temporal, amplitude, and/or frequency properties due to the interactions with the space's physical characteristics. Together, how sound waves 105 and 108 arrive at the receiver and are varied from the source sound waves 103 define the acoustical characteristics of a space, which are experienced as sound echoes, shape, clarity, spaciousness, warmth, liveliness, reverberance decay, etc.

An ambisonic audio system may capture (e.g., sense, record) the full fidelity of the sound, including all of the space's acoustical characteristics, using an ambisonic microphone as the receiver 101. Ambisonic audio is a full-sphere periphony that may be used in many virtual reality and/or other immersive applications. Ambisonic audio may be captured with an ambisonic microphone that senses sound coming from all directions and encoded by the system according to ambisonic formats having multiple separate channels. For example, a first-order ambisonic B-format may have four channels labeled W, X, Y, and Z. The W channel corresponds to the mono output from an omnidirectional microphone, while the X, Y, and Z channels correspond to directional components of the sound signal. In other examples, the captured sound may be encoded into 2^{nd} order, 3^{rd} order, or other M^{th} order ambisonic format.

As described in more detail herein, an ambisonic sound system may be used to capture the acoustical characteristics of a physical space and, through audio signal processing, apply those characteristics to modify any recorded sound such that the modified recorded sound appears as if it was originally generated and captured in the physical space. Various examples are further described below in modifying the captured ambisonic acoustical characteristics to change the acoustic properties of the space artificially.

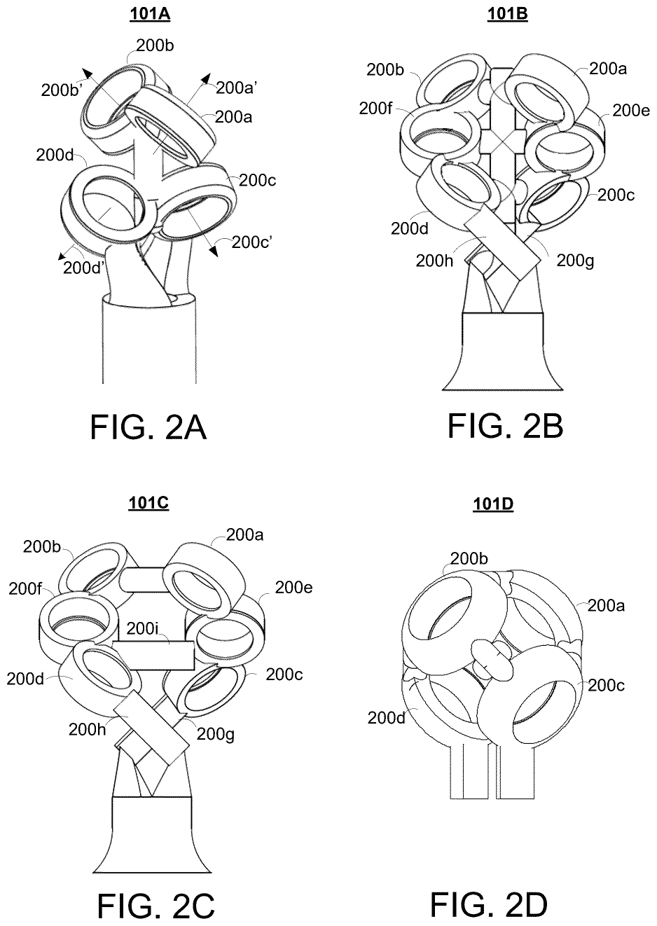

FIGS. 2A-2D illustrate example ambisonic microphones 101A-101D, respectively, that may be used to implement one or more illustrative aspects described herein (e.g., microphone 101). Microphones 101A-101D may include microphone capsules 200a-200n (hereinafter collectively referred to as “microphone capsules 200”), including any quantity of microphone capsules. For example, microphones 101A and 101D include four microphone capsules 200a-200d, microphone 101B includes eight microphone capsules 200a-200h, and microphone 101C includes nine microphone capsules 200a-200i. The microphone capsules may be any type of capsule, such as condenser (e.g., including large- and small-diaphragm and electret condenser), dynamic (e.g., including moving coil and ribbon microphones), and/or micro-electromechanical systems (MEMS), among others. The microphone capsules may be constructed according to one or more geometries (e.g., round, oval, elliptical, rectangular, etc.). The microphone capsules may have unidirectional, cardioid, supercardioid, hypercardioid, and/or bidirectional pickup patterns.

Microphones 101A-101D may include one or more structures (e.g., base, yoke, stem) adapted to hold (e.g., be integrally attached to) each of microphone capsules 200a-200n at a different position oriented to sense sound in a different direction.

For example, referring to microphone 101A in FIG. 2A, microphone capsule 200a may be positioned in a direction indicated by line 200a′, microphone capsule 200b may be positioned in a direction indicated by line 200b′, microphone capsule 200c may be positioned in a direction indicated by line 200c′, and microphone capsule 200d may be positioned in a direction indicated by line 200d′. Lines 200a′, 200b′, 200c′, and 200d′ may represent an axis of maximum sensitivity (e.g., an axis through the center of the microphone capsule projecting infinitely in the positive direction) and/or minimum sensitivity (i.e., said axis projecting infinitely in the negative, or opposite, direction) for microphone capsules 200a, 200b, 200c, and 200d, respectively. In some examples, axes of minimum sensitivity of microphone capsules 200a and 200d (i.e., along lines 200a′ and 200d′, respectively) may intersect at a point in space (i.e., lines 200a′ and 200d′ may share at least one coincident point of intersection). In some examples, axes of minimum sensitivity of microphone capsules 200b and 200c (i.e., along lines 200b′ and 200c′, respectively) may intersect at a point in space (i.e., along lines 200b′ and 200c′ may share at least one coincident point of intersection).

The faces of microphone capsules 200a and 200b (i.e., the sides of microphone capsules 200a and 200b that correspond to the maximum acoustic sensitivity of capsules 200a and 200b) may be oriented substantially upward-facing, and oriented relative to one another to form an angle (e.g., 65 degrees to 95 degrees) along a first horizontal axis that passes through the centers of microphone capsules 200a and 200b. Similarly, the faces of microphone capsules 200c and 200d (may be oriented substantially downward-facing and oriented relative to one another to form an angle (e.g., 65 degrees to 95 degrees) along a second horizontal axis that passes through the centers of microphone capsules 200c and 200d. A vertical distance may separate the first horizontal axis and the second horizontal axis. From a top view, the first and second horizontal axes may be offset by a 90-degree angle.

As shown in FIG. 1D, microphone 101D may include the same or similar microphone capsules 200a-200d pointing in the same directions as in microphone 101A, but in microphone 101D, the capsules have a different layout with respect to each other. For example, microphone 101D may be described as having microphone capsules 200a-200d centered on vertices of an imaginary tetrahedral or on the surface of a sphere. Other microphones may have other arrangements for the microphone capsules.

As shown in FIGS. 2B and 2C, the ambisonic microphone may include more than four microphone capsules. For example, microphone 101B includes eight capsules 200a-200h arranged in four pairs vertically offset from one another and arranged at successive 45-degree angles about the z-axis. As another example, microphone 101C has the same eight microphone capsules 200a-200h as microphone 101B, plus an additional capsule 200i oriented with its maximum sensitivity direction pointing the z-axis direction. While FIGS. 2A-2D illustrate a few ambisonic microphones, other ambisonic microphones with more or less microphone capsules may be used in the examples described herein.

Ambisonic microphones, such as 101A, 101B, 101C, and 101D, may be configured to capture a complete sphere of sound in all directions. Microphone capsules 200a-200n may be geometrically arranged and compactly nested relative to one another such that the microphone capsules may exhibit a consistent and/or stable polar response at high frequencies. The microphone capsules may be compactly nested together to help minimize phase-related errors and/or to help provide higher spatial/localization accuracy. The microphone capsules may be geometrically oriented to reduce the acoustic shading due to structural interference introduced by one or more adjacent microphone capsules. The geometric orientation of the microphone capsules may reduce acoustic shading by decreasing the cross-section(s) of the obstruction caused by adjacent microphone capsules, which may help improve high-frequency response.

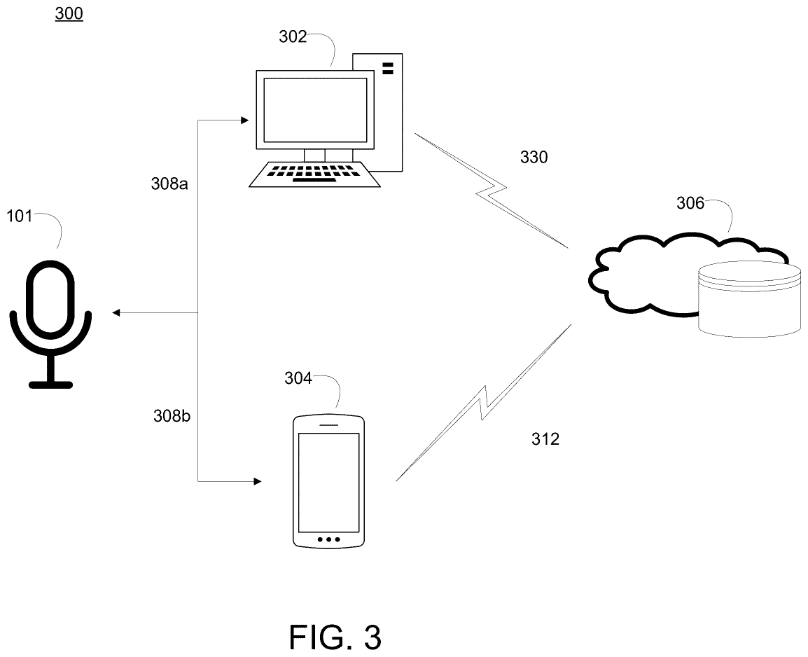

FIG. 3 illustrates an example of an ambisonic audio system 300 that may be used to implement one or more illustrative aspects described herein in a standalone and/or networked environment. The audio device 101 may be an ambisonic microphone as described with respect to FIGS. 1 and 2 (e.g., 101A, 101B, 101C, 101D). Audio device 302 may be one or more computing devices, such as a desktop computer, a laptop computer, one or more cloud computing devices, one or more servers, etc. Audio device 304 may be a smartphone or tablet. Audio device 101 may be connected (wired or wirelessly) to and/or in communication with one or more of audio devices 302 and/or 304. In one or more examples, device 306 may comprise a data server, such as a cloud-based data server. Audio device 101 may be connected (wired or wirelessly) to and/or in communication with one or more other audio devices (not shown), including, but not limited to, a mixing console, a recording console, and the like. Any one or more of devices 101, 302, 304, and 306 may be any type of known computer or server. In one or more examples, audio device 302 and/or audio device 304 may include a user interface, such as a graphical user interface, to allow a user to interact with the system. Devices 101, 302, 304, and/or 306 may be interconnected via a wide area network (WAN), such as the Internet, and/or via any other network. For example, one or more other networks may also or alternatively be used, such as a local area network (LAN), a wireless network, a personal network (PAN), and the like. Devices 101, 302, 304, and/or 306, and/or other devices (not shown), may or might not be communicatively connected to one or more networks via twisted pair wires, coaxial cable, fiber optics, radio waves, and/or other communication media. In one or more examples, audio device 101 may be communicatively connected to audio device 302 and/or audio device 304 via connections 308a and/or 308b, respectively. Audio device 302 and/or audio device 304 may connect to audio device 101 via connections 308a and/or 308b using any one or more of a variety of different connectors, such as a LEMO connector, an XLR connector, a Lightning® connector, a TQG connector, a TRS connector, a USB connector (including, but not limited to, USB type A, type B, type C, Mini B, Micro B), and/or one or more RCA connectors. Connections 308a and/or 308b may be wireless and connect to the audio device 101 using any one or more protocols, such as WiMAX, LTE, Bluetooth, Bluetooth Broadcast, Bluetooth Low Energy, (BLE), GSM, 3G, 4G, 5G, 6G, Zigbee, 60 GHz Wi-Fi, Wi-Fi (e.g., compatible with IEEE 802.33a/b/g/n/ac/ad/af/ah/ai/aj/aq/ax/ay/ba/be), one or more proprietary wireless connection protocols, one or more NFC protocols, and/or any other protocol(s). Where the connection is wireless, audio devices 302 and 304 (and/or their respective transmitters, receivers, or transceivers) and audio device 101 may include a wireless communications interface. In one or more examples, audio device 302 may be communicatively connected to device 306 via connection 330, and/or audio device 304 may be communicatively connected to device 306 via connection 332 (e.g., via wired and/or wireless networks).

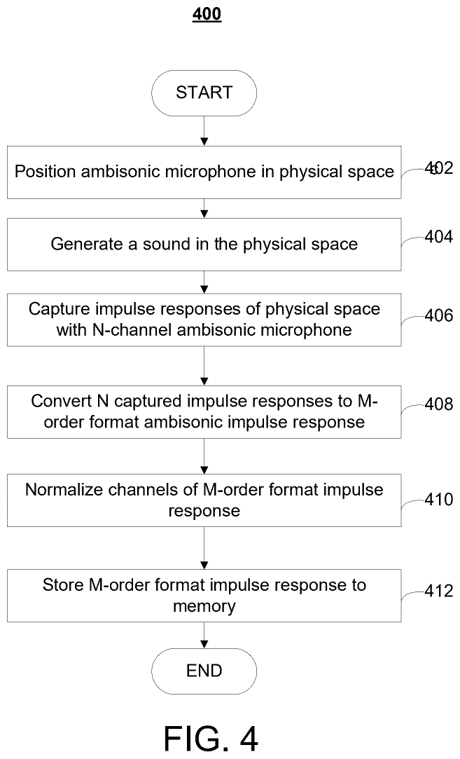

As previously discussed, an ambisonic audio system (e.g., 300) may be used to capture the acoustical characteristics of a physical space (e.g., 100) and, through audio signal processing, apply those characteristics to modify any recorded sound such that the modified recorded sound appears as if it was originally generated and captured in the physical space. FIG. 4 shows an example process for capturing the acoustical characteristics of a physical space in the form of an ambisonic impulse response.

In step 402, one or more ambisonic microphones may be positioned in the physical space. For example, one of the ambisonic microphones 101A-101D, as shown in FIGS. 2A-2D, may be positioned in a physical space 100, as shown in FIG. 1.

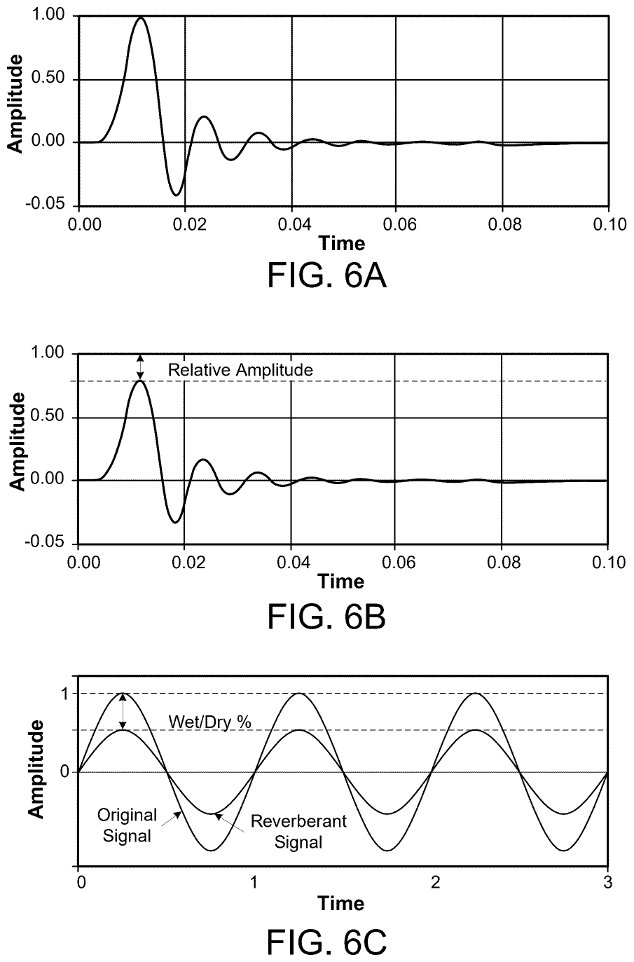

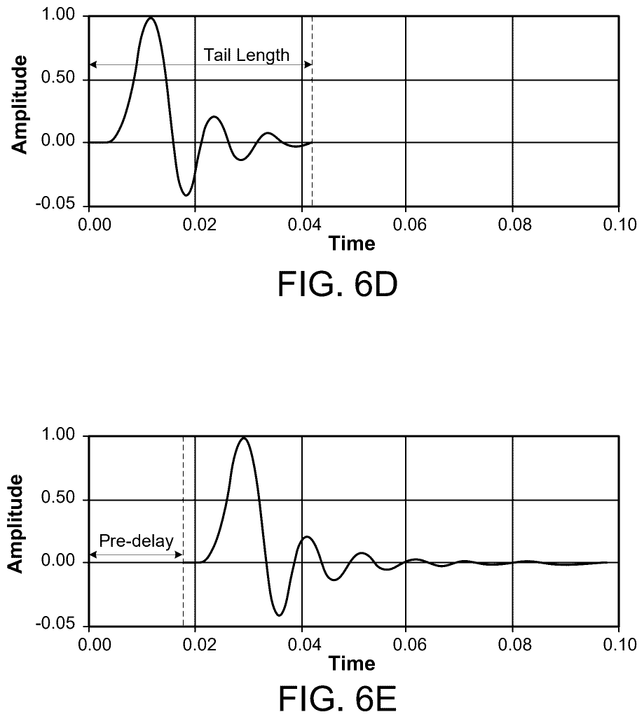

In step 404, a sound is generated in the space, for example, from source 102, as shown in FIG. 1. In step 406, the ambisonic microphone may sense, based on the generation of the sound, multiple impulse responses of the space. For example, multiple (e.g., N) microphone capsules of ambisonic microphone 101 may capture N different impulse responses, each being received from a different direction based on the various orientations of the microphone capsules. An impulse response is the audible sound received by a microphone capsule that is produced in response to a brief sound (e.g., an “impulse”) generated by the source 102 interacting with the physical space's structures, objects, and atmosphere. An example of an impulse response is illustrated in FIG. 6A, further discussed below.

Various techniques may be used to capture the ambisonic impulse response. For example, the sound source 102 may generate an impulse sound (e.g., a clap) that ideally has a flat amplitude over a wide frequency band (e.g., the audible frequency band). The recorded sound will thus include all direct and reverberated sounds (e.g., 105 and 108) (across the wide frequency band) that characterize the space. In another example, the sound source 102 may generate a sine sweep sound, which is a sound that varies its frequency (e.g., from low to high across the audible frequency band) over time. The microphone capsules of microphone 101 may sense the response at each of the frequencies in the sweep and combine those responses into a single impulse response.

In step 408, the multiple (e.g., N) impulse responses captured by the microphone capsules are converted (e.g., mapped, projected) to an M-order formatted ambisonic impulse response. For example, a first-order (M=1) ambisonic impulse response may include a B-formatted signal with X, Y, Z, and W channels, where X, Y, and Z represent three bidirectional impulse responses in orthogonal directions, and W represents an omnidirectional impulse response. Using microphone 101A in FIG. 2A or 101D in FIG. 2D, for example, a first-order B-format ambisonic impulse response may be generated using the following conversion:

$$W = FLU + FRD + BLD + BRU$$

$$X = FLU + FRD - BLD - BRU$$

$$Y = FLU - FRD + BLD - BRU$$

$$Z = FLU - FRD - BLD + BRU$$

where FLU (front left up) may represent the impulse response captured by microphone capsule 200a, BRU (back right down) may represent the impulse response captured by microphone capsule 200b, BLD (back left down) may represent the impulse response captured by microphone capsule 200c, and FRD (front right down) may represent the impulse response captured by microphone capsule 200 d. In some examples, the W-channel may be attenuated by about 3 dB (i.e., by a factor of the square root of 2 or 0.707). Any number of ambisonic formats, including, for example, FuMa, Ambix, and the like, may be used and supported.

In other examples, e.g., for the microphones 101B and 101C, first-order B-format audio signals may be generated by secondary processing of two sets of first-order B-format audio signals: a first set of B-format audio signals generated from a first base set of audio data from a first base set of microphone capsules (e.g., 200a-200d), and a second set of B-format audio signals generated from a second base set of audio data from a second base set of microphone capsules (e.g., 200e-200h). To encode a first set of first-order B-format audio signals, the above matrix operation may be applied to the first base set of microphone capsules 200a-200d as described above. The above matrix operation may be applied to the second base set of microphone capsules 200e-200h as described above to encode a second set of B-format audio signals. The impulse responses (e.g., A-formatted signals) received by the microphone capsules may be converted into second-, third-, and higher-order ambisonic formatted signals using similar techniques.

In step 410, the channels of ambisonic impulse response (e.g., in an M-order format) may be normalized such that all channels have the same maximum amplitude.

In step 412, the ambisonic impulse response may be stored in a memory, e.g., for later application to audio signals.

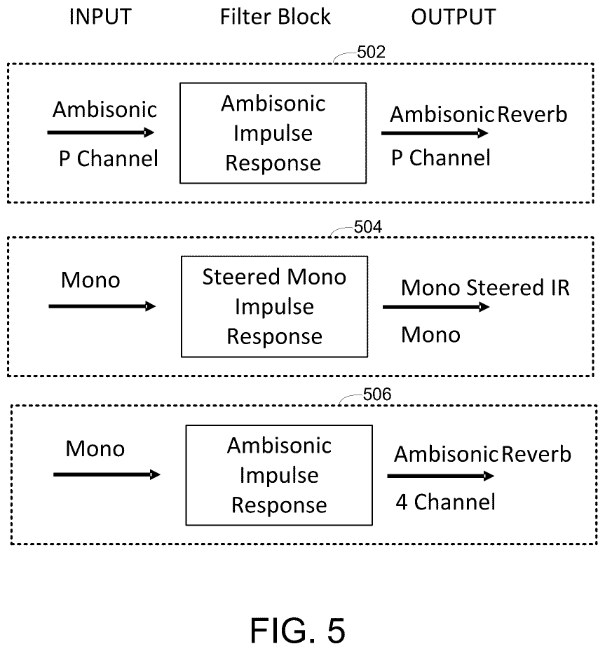

As shown in FIG. 5, once created, the ambisonic impulse response can be used in a filter to apply a physical space's directional acoustical characteristics (e.g., ambisonic reverberation effects) to an input audio signal. As described above, the ambisonic impulse response may have multiple channels, such as X, Y, Z, and W, where each channel includes a space's impulse response in a particular direction (e.g., X, Y, or Z directions) or a space's omnidirectional impulse response (e.g., W). An input audio signal channel may be convolved with a channel of the ambisonic impulse response to apply the reverberation effects of that input response channel to the audio signal channel.

As shown in FIG. 5, the filter may receive an input audio signal that is monophonic or multi-channeled (e.g., ambisonic) to apply the directional reverberations of the physical space to the audio signal in different ways. For example, as shown in block 502, an ambisonic audio signal with P (e.g., four) channels may be input to an ambisonic impulse response filter with corresponding P (e.g., four) channels. For example, the input audio signal and the ambisonic impulse response may both be coded in B-format with X, Y, and Z directional channels and a W omnidirectional channel. Each channel of the input audio signal may be convolved with the corresponding channel of the ambisonic impulse response to apply the directional reverberations of the physical space channel-by-channel to the audio signal (e.g., an ambisonic reverberated audio signal). That is, the X channel of the audio input signal may be convolved with the X channel of the ambisonic impulse response, the Y channel of the audio input signal may be convolved with the Y channel of the ambisonic impulse response, the Z channel of the audio input signal may be convolved with the Z channel of the ambisonic impulse response, and the W channel of the audio input signal may be convolved with the W channel of the ambisonic impulse response. In other examples, the ambisonic audio signal may be transformed (e.g., rotated in a particular direction) prior to being convolved with the ambisonic impulse response to give the effect that the audio source was transformed (e.g., rotated) in the physical space in the same manner.

In another example, as shown in block 504, a monophonic (single channel) audio signal may be input to a steered mono impulse response filter that includes multiple channels, such as a B-format impulse response with X, Y, Z, and W channels. The steered mono impulse response can be spatially interpolated to a monophonic impulse response pointing in a selected direction, which may then be convolved with the monophonic audio signal. For example, to apply a direction with an azimuth angle of 45 degrees and a polar angle of 45 degrees, each of the X, Y, and Z channels of the steered mono impulse response can be scaled by 0.707 and then vector summed with the W channel to generate the monophonic impulse response, which is convolved with the monophonic audio signal.

In another variation of block 504, the monophonic audio signal may be mapped (e.g., beam-formed) in a particular direction and converted to a multi-channel audio signal before convolving with the ambisonic impulse response. For example, the monophonic audio signal can be steered to emphasize the space's reverberation response in a particular spherical direction. For example, the monophonic audio signal may be beam-formed to point in a direction with an azimuth angle of 45 degrees and a polar angle of 45 degrees so that a B-format signal is generated with equal parts in the X, Y, and Z channels, each 0.707 times the magnitude of the monophonic audio signal. The B-format signal may then be convolved with the impulse response, and then mapped back to a monophonic output signal (e.g., by calculating the magnitude of the signal), resulting in the monophonic output signal having reverberation characteristics of the space pointing in the steered direction.

In each example of block 504, the direction of the monophonic signal can be updated to steer the signal in different directions and with different amounts of the omnidirectional component to emphasize different aspects of the room's response. In some examples, the monophonic signal may be mapped to take on some of the omnidirectional W components of the ambisonic impulse response in addition to a particular direction.

In a further example, as shown in block 506, a monophonic input audio signal may be mapped to multiple channels of an ambisonic audio signal before being convolved with an ambisonic impulse response as previously described with respect to block 504. For example, a user may want to emphasize the X and Y axes of the space over the Z axis and omnidirectional direction of the room, and thus map the monophonic input audio signal to the X and Y channels of an ambisonic audio signal that is convolved with the ambisonic impulse response to produce an ambisonic audio signal with X and Y reverberated channels. In other examples, the monophonic input audio signal is mapped to all four channels to generate an ambisonic audio signal with X, Y, Z, and W reverberated channels.

In the examples above, the ambisonic impulse response includes multiple channels to represent different directions within the space. For example, the X channel may represent the reverberation properties of a space in the left and right directions, the Y channel may represent the reverberation properties of a space in the front and back directions, the Z channel may represent the reverberation properties of a space in the top and bottom directions, and the W may represent the omnidirectional reverberation properties. Further examples include modifying one or more channels of the ambisonic impulse response to artificially alter the acoustical properties of a physical space. For example, a concert hall or a cathedral may have been built with desirable acoustical properties, but at some point, it was renovated by adding a balcony, which may have muddled some of the acoustical characteristics. As modified, the reverberation of the space may be unchanged in the left and right directions (e.g., the X channel) and in the front and back directions (e.g., the Y channel), but the new balcony may add unintended or undesirable echoes and acoustical artifacts in the up and down directions. To remedy this, an ambisonic impulse response of the modified space may be altered to spatially focus and/or adjust the perception level of certain channels so that desirable channels are emphasized (e.g., the X and Y channels), and undesirable channels are deemphasized.

FIGS. 6A-6E show various ways of altering a channel impulse response, which adjust focus and perception of a space's reverberation properties. FIG. 6A illustrates an example channel impulse response of an ambisonic impulse response, for example, as captured according to process 400 described above. The impulse response includes an initial delay from the generation of the impulse sound at time 0.00, followed by an oscillating signal that decays over time. The peak amplitude of the impulse in FIG. 6A is normalized to 1 for convenience.

FIGS. 6B and 6C illustrate two ways to modify the impulse response's amplitude for adjusting the focus level (or prioritization level) of one channel with respect to the other channels in the ambisonic impulse response. In FIG. 6B, the relative amplitude of the impulse response may be adjusted up or down to focus (prioritize) or defocus (deprioritize) the channel, respectively, with respect to other channels in the ambisonic impulse response. FIG. 6C illustrates the reverberant signal (the original signal convolved with the impulse response) and the original signal. The reverberant signal (e.g., the wet signal) may be combined with the original signal (the dry signal) in a ratio referred to as the wet/dry percentage and output from the ambisonic impulse response filter. In some examples, the wet/dry percentage for a particular channel may be adjusted up or down to focus (prioritize) or defocus (deprioritize) the channel, respectively, with respect to other channels in the ambisonic impulse response.

FIGS. 6D and 6E illustrate two ways to modify the impulse response's timing for adjusting the perception level of one channel with respect to the other channels in the ambisonic impulse response. In FIG. 6D, the tail length of an impulse response (e.g., the duration of the impulse response) may be adjusted, where shorter and longer tail lengths reduce and increase the perception of the reverberation effects (e.g., how long in time the signal reverberates or echoes), respectively. In FIG. 6E, a -pre-delay may be added to or subtracted from the beginning of the impulse response, which, for example, may have the effect of artificially increasing or decreasing the distance between walls in the direction of the impulse response.

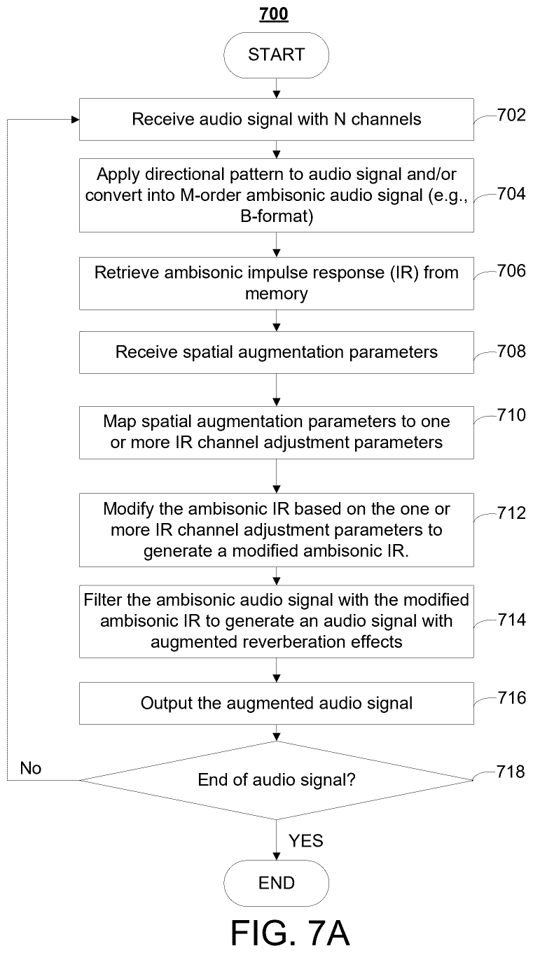

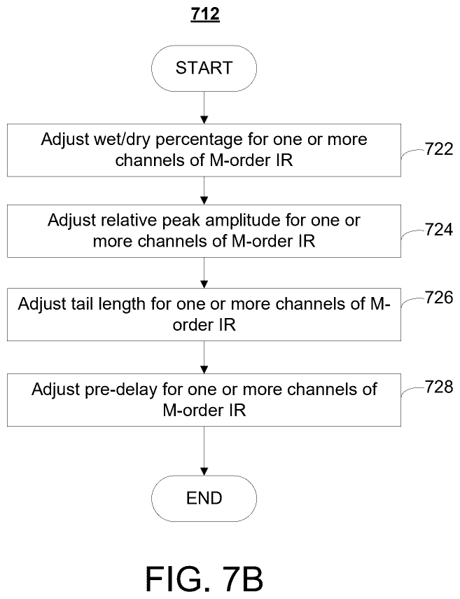

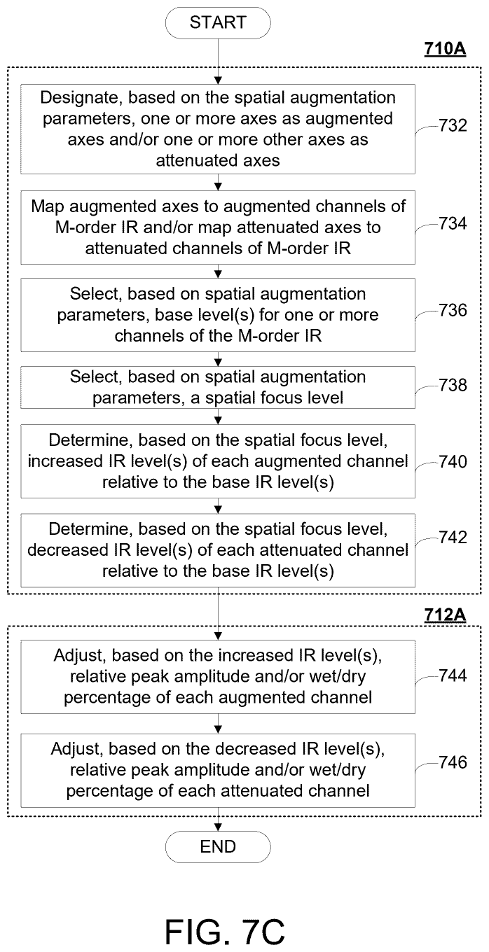

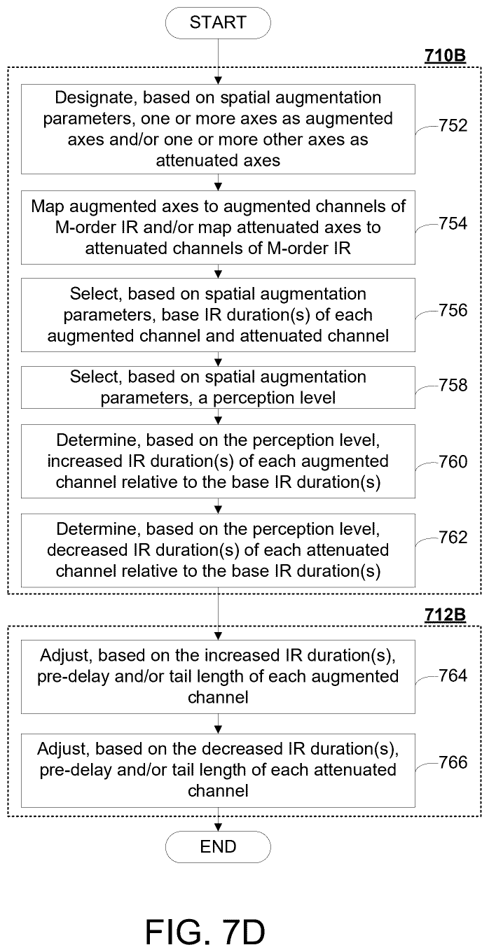

FIG. 7A shows an example process 700 for manipulating an ambisonic reverberation signal, for example, by modifying the ambisonic impulse response as shown in FIGS. 6B-6E. Process 700, for example, may be performed by audio devices 101, 302, and/or 304 as previous described, and/or by system 900 as described below.

The process starts at step 702, an audio signal may be received (e.g., by an audio device 101, 302, 304, and/or 900), which may be a monophonic audio signal or an ambisonic audio signal as previously described with respect to FIG. 5.

In step 704, the received audio signal may be mapped, formatted, or otherwise converted (e.g., by an audio device 101, 302, 304, and/or 900) into an ambisonic audio signal (e.g., B-format audio signal). For example, as previously described with respect to step 408 of FIG. 4, multiple audio signals (e.g., 4, 8, 9 channels) generated by microphone capsules, respectively, of an ambisonic microphone may be converted to a 1^{st}, 2^{nd}, 3^{rd}, or higher order ambisonic signal (e.g., in B-format). As another example, as previously described with respect to FIG. 5, a monophonic audio signal may be mapped to one or more channels of an ambisonic audio signal based on a directional pattern (e.g., beam forming the monophonic signal in a steered direction). In further examples, a monophonic or an ambisonic audio signal may be transformed into another ambisonic audio signal, for example, by applying a directional pattern, such as by rotating the audio signal's directional orientation or changing the audio signal's order.

In step 706, an ambisonic impulse response is retrieved (e.g., by an audio device 101, 302, 304, and/or 900) from memory or another location (e.g., cloud storage). The ambisonic impulse response may be of any order (e.g., 1^{st}, 2^{nd}, 3^{rd}, etc.), be in a standard ambisonic format (e.g., B-format), and/or have multiple channels (e.g., X, Y, Z, W) as previously described with respect to FIGS. 4, 5, and 6A-6E.

In step 708, one or more spatial augmentation parameters may be received (e.g., by an audio device 101, 302, 304, and/or 900). The spatial augmentation parameters may include one or more parameters for adjusting or enhancing the reverberation effects of the ambisonic impulse response. For example, the augmentation parameters may include instructions and/or parameters indicating an augmentation parameter such as an adjustment in the focus and/or the perception of one or more reverberation effects of a physical space corresponding to the ambisonic impulse response. The instructions and/or parameters may identify one or more spatial directions to apply an augmentation. For example, the augmentation parameters may include a direction (e.g., polar and/or azimuth angles, a unit vector, etc.) to which an adjusted focus or perception level is to be applied.

In step 710, the spatial augmentation parameter may be mapped (e.g., by an audio device 101, 302, 304, and/or 900) to one or more channel adjustment parameters of one or more channels of the ambisonic impulse response. Channel adjustment parameters may include a change in relative amplitude, wet/dry percentage, pre-delay, and/or tail length of a channel of the ambisonic impulse response, as shown in FIGS. 6B-6E. For example, an augmentation parameter may include a focus parameter corresponding to a change (increase or decrease) in an amplitude adjustment parameter (e.g., relative amplitude and/or wet/dry percentage) of one or more channels of the ambisonic impulse response. In another example, an augmentation parameter may include a perception parameter corresponding to a timing adjustment parameter (e.g., pre-delay and/or tail length) of one or more channels of the ambisonic impulse response.

The channels of the ambisonic impulse response to which the augmentation (e.g., focus and/or perception) is mapped may be based on a direction included in the spatial augmentation parameter. For example, a focus or perception parameter may be applied to adjustment parameters of the X channel of the ambisonic impulse response based on an indicated direction in the augmentation parameters pointing along the X axis. In another example, an indicated direction having an azimuth angle of 45 degrees and a polar angle of 45 degrees may be applied with equal parts to the X, Y, and Z channels (e.g., each 0.707 times the effect to normalize the mapping). In some examples, a focus or perception parameter that is mapped to an adjustment parameter in one direction (e.g., an increase in relative amplitude) of one channel (e.g., the X channel) of the ambisonic impulse response may additionally or alternatively be mapped to an opposite adjustment parameter in the other directions (e.g., the Y and Z channels) of the ambisonic impulse response.

In step 712, one or more of the channels of the ambisonic impulse response may be modified (e.g., by an audio device 101, 302, 304, and/or 900) based on the one or more adjustment parameters to generate a modified ambisonic impulse response. FIG. 7B shows substeps that may be performed in step 712 of FIG. 7A for modifying the channels of the ambisonic impulse response. As previously discussed, the ambisonic impulse response may be of any (M) order (e.g., 1^{st}, 2^{nd}, 3^{rd}, etc.). In step 722, an audio device (e.g., 101, 302, 304, and/or 900) may adjust the wet/dry percentages of one or more channels (e.g., X, Y, Z, and/or W channels) of the M-order impulse response based on the channel adjust parameters determined in step 710. In step 724, an audio device (e.g., 101, 302, 304, and/or 900) may adjust the relative peak amplitudes of one or more channels (e.g., X, Y, Z, and/or W channels) of the M-order impulse response based on the channel adjust parameters determined in step 710. In step 726, an audio device (e.g., 101, 302, 304, and/or 900) may adjust the tail lengths of one or more channels (e.g., X, Y, Z, and/or W channels) of the M-order impulse response based on the channel adjust parameters determined in step 710. In step 728, an audio device (e.g., 101, 302, 304, and/or 900) may adjust the pre-delays of one or more channels (e.g., X, Y, Z, and/or W channels) of the M-order impulse response based on the channel adjust parameters determined in step 710.

Returning to FIG. 7A, in step 714, the ambisonic audio signal is filtered with the modified ambisonic impulse response (e.g., by an audio device 101, 302, 304, and/or 900) to generate an augmented ambisonic audio signal. For example, X, Y, Z, and W channels of the ambisonic audio signal may be convolved, respectively, with X, Y, Z, and W channels of the modified ambisonic impulse response to generate an ambisonic audio signal with augmented reverberation effects that has been modified according to the spatial augmentation parameters received in step 708. Step 714 may include mapping the ambisonic audio signal with the augmented reverberation into an audio signal with a different number or orientation of channels. For example, the X, Y, and Z components of the augmented audio signal may then be mapped back to a monophonic output signal (e.g., by calculating the magnitude of the signal in a steered direction), resulting in the monophonic output signal having reverberation characteristics of the space scaled according to the steered direction (e.g., scaled according to the X, Y, and Z components of a vector pointing in the steered direction).

In step 716, the augmented audio signal is output (e.g., by an audio device 101, 302, 304, and/or 900), for example, to a memory for storage or to an audio system for decoding and playback via speakers. In step 718, it is determined (e.g., by an audio device 101, 302, 304, and/or 900) whether the audio signal has ended. If the audio signal has ended, process 700 is finished. If the audio signal has not ended, the process returns to step 702 to continue receiving and processing the audio signal. As the process is repeated during the reception of the audio signal, the augmentation parameters may be varied (e.g., in step 708) so that the changes may be experienced during playback.

FIG. 7C shows further details that may be included in steps 710 and 712 of FIG. 7A, in which the spatial augmentation parameters include a spatial focus level. Step 710 may be performed as step 710A and include substeps 732-742 for mapping spatial augmentation parameters to one or more impulse response channel adjustment parameters. Step 712 may be performed as step 712A, which includes substeps 744-746 for modifying the ambisonic impulse response.

In step 732, an audio device (e.g., an audio device 101, 302, 304, and/or 900) may designate, based on the spatial augmentation parameters received in step 708, one or more axes as augmented axes and/or one or more other axes as attenuated axes. For example, if one or more of the augmentation parameters indicate a direction (e.g., as indicated by a vector) to augment (or attenuate), each axis (e.g., in a cartesian coordinate space) on which the indicated direction can be projected, may be designated as an augmented (or attenuated) axis. For example, an indicated direction in the X-Y plane with a 45-degree azimuth angle projects onto the X and Y axes equally and does not project onto the Z axis. The X and Y axes may be designated as augmented axes for this direction. In some examples, based on at least one axis being designated as an augmented axis, each axis not designated as an augmented axis may be designated as an attenuated axis. Similarly, in some examples, based on at least one axis being designated as an attenuated axis, each axis not designated as an attenuated axis may be designated as an augmented axis. In some examples, an omnidirectional pattern may be designated as an augmented or attenuated axis (even though it is not an axis in a cartesian coordinate space) based on the spatial augmentation parameters.

In step 734, the audio device (e.g., an audio device 101, 302, 304, and/or 900) may map the augmented axes to augmented channels of the M-order ambisonic impulse response and/or map attenuated axes to attenuated channels of the M-order impulse response. For example, X, Y, Z, and/or W augmented (or attenuated) axes may be mapped to augmented (or attenuated) X, Y, Z, and W channels of a first or higher-order ambisonic impulse response. The augmented and/or attenuated axes may be mapped to augmented and/or attenuated higher-order channels in 2^{nd} and higher-order ambisonic impulse responses based on the higher-order channels having a non-zero component in the direction of the augmented and/or attenuated axes, respectively. In some examples, the augmented and/or attenuated axes may be mapped to an augmented and/or attenuated higher-order channel based on all directional components of the higher-order channel corresponding to augmented and/or attenuated axes, respectively.

In step 736, the audio device (e.g., an audio device 101, 302, 304, and/or 900) may select base level(s) for one or more channels of the ambisonic impulse response. For example, the base levels may be the same as the normalized levels for the channels, as discussed with respect to step 410 of process 400. In some examples, the base levels may be based on the spatial augmentation parameters. For example, the spatial augmentation parameters may indicate an augmentation or attenuation level for all of the channels of the ambisonic impulse response.

In step 738, the audio device (e.g., an audio device 101, 302, 304, and/or 900) may select, based on spatial augmentation parameters, a spatial focus level. The spatial focus level may be an adjustment relative to the base levels for each augmented and/or attenuated channel.

In step 740, the audio device (e.g., an audio device 101, 302, 304, and/or 900) may determine, based on the spatial focus level, increase(s) in impulse response level(s) of each augmented channel relative to the base impulse response level(s). In step 742, the audio device (e.g., an audio device 101, 302, 304, and/or 900) may determine, based on the spatial focus level, decrease(s) in impulse response level(s) of each attenuated channel relative to the base impulse response level(s). In some examples, for a determined spatial focus level, the amount of increase for each augmented channel may be the same as the amount of decrease for each attenuated channel. In some examples, the amount of increase for augmented channels and the amount of decrease for attenuated channels may be different for a spatial focus level (e.g., linearly adjusted according to the spatial focus level according to different magnitude coefficients).

In step 744, the audio device (e.g., an audio device 101, 302, 304, and/or 900) may adjust, based on the increased impulse response level(s), relative peak amplitude and/or wet/dry percentage of each augmented channel. In step 746, the audio device (e.g., an audio device 101, 302, 304, and/or 900) may adjust, based on the decreased impulse response level(s), relative peak amplitude and/or wet/dry percentage of each attenuated channel. In some examples, a change in the spatial focus level corresponds (e.g., linearly, logarithmically) to the change in the relative amplitude and/or wet/dry percentage.

FIG. 7D shows further details that may be included in steps 710 and 712 of FIG. 7A, in which the spatial augmentation parameters include a perception level. Step 710 may be performed as step 710B and include substeps 752-762 for mapping spatial augmentation parameters to one or more impulse response channel adjustment parameters. Step 712 may be performed as step 712B, which includes substeps 764-766 for modifying the ambisonic impulse response. Steps 752 and 754 may be performed similarly to steps 732 and 734 of FIG. 7C.

In step 756, the audio device (e.g., an audio device 101, 302, 304, and/or 900) may select base durations(s) for one or more channels of the ambisonic impulse response. For example, the base durations may be the same as the normalized durations for the channels, as discussed with respect to step 410 of process 400. In some examples, the base durations may be based on the spatial augmentation parameters. For example, the spatial augmentation parameters may indicate an augmentation or attenuation duration for all of the channels of the ambisonic impulse response.

In step 758, the audio device (e.g., an audio device 101, 302, 304, and/or 900) may select, based on spatial augmentation parameters, a perception level. The perception level may be an adjustment relative to the base duration for each augmented and/or attenuated channel.

In step 760, the audio device (e.g., an audio device 101, 302, 304, and/or 900) may Determine, based on the perception level, increase(s) in impulse response durations(s) of each augmented channel relative to the base impulse response duration(s). In step 762, the audio device (e.g., an audio device 101, 302, 304, and/or 900) may determine, based on the perception level, decrease(s) in impulse response durations(s) of each attenuated channel relative to the base impulse response duration(s). In some examples, for a determined perception level, the amount of increase for each augmented channel may be the same as the amount of decrease for each attenuated channel. In some examples, the amount of increase for augmented channels and the amount of decrease for attenuated channels may be different for a perception level (e.g., linearly adjusted according to the perception level according to different magnitude coefficients).

In step 764, the audio device (e.g., an audio device 101, 302, 304, and/or 900) may adjust, based on the increased duration(s), the pre-delay and/or the tail length of each augmented channel. In step 766, the audio device (e.g., an audio device 101, 302, 304, and/or 900) may adjust based on the decreased duration(s), the pre-delay, and/or the tail length of each attenuated channel. In some examples, a change in the perception level corresponds (e.g., linearly, logarithmically) to the change in the pre-delay and/or tail length.

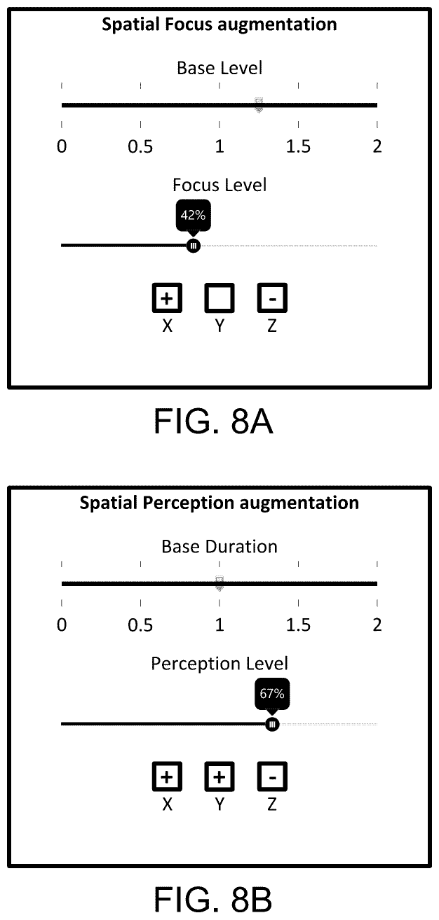

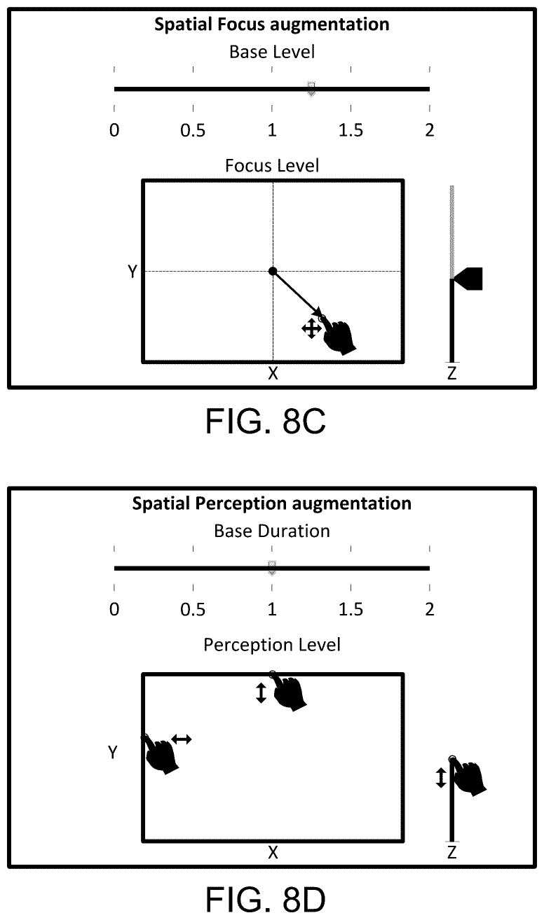

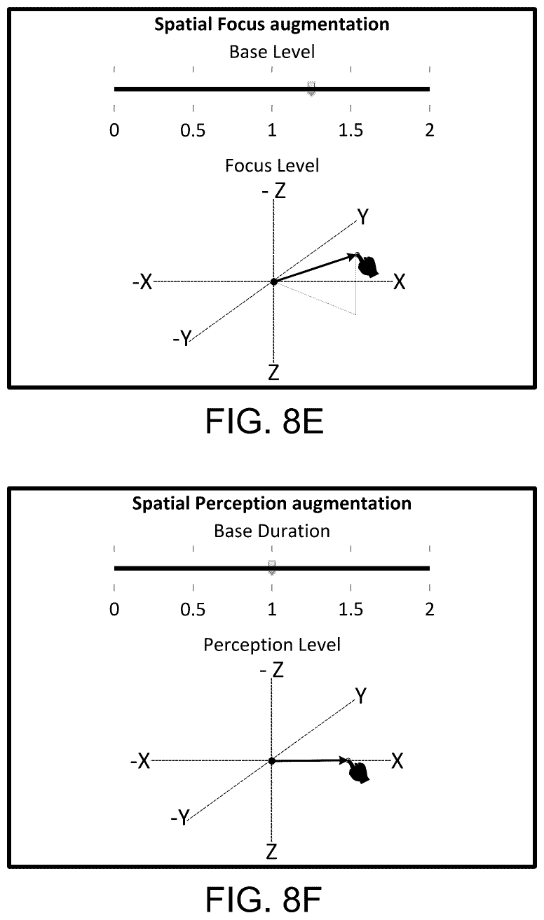

FIGS. 8A-8F show example graphical user interfaces for manipulating an ambisonic reverberation signal according to illustrative aspects described herein. For example, the graphical user interfaces may be generated by an audio device (e.g., 101, 302, 304, and/or 900) via a user interface, such as a touch screen. FIGS. 8A, 8C, and 8E show graphical user interfaces for setting spatial focus parameters, for example, as described with respect to FIG. 7C and FIGS. 8B, 8D, and 8E show graphical user interfaces for setting perception level parameters, for example, as described with respect to FIG. 7D.

The graphical user interfaces may include an input feature configured to receive a user's input to set or adjust a base level (FIGS. 8A, 8C, 8E) or a base duration (FIGS. 8B, 8D, 8F) for the impulse response channels of the ambisonic impulse response. The base level and base duration input features, for example, may be used to set a base level as described with respect to step 736 of FIG. 7C or a base duration as described with respect to step 756 of FIG. 7D. As previously described, for each channel of the ambisonic impulse response, the base level corresponds to the relative amplitude and/or wet/dry percentage of the channel and the base duration corresponds to the pre-delay and tail length of the channel. The base level and base duration input features may include a knob, pull-down menu, dial, text entry field, slider, radio button, or other adjustment features for selecting or inputting a base level or base duration. In some examples, the base level or base duration may have a nominal level (e.g., 1), which may correspond to the original or normalized levels or durations of each channel of the ambisonic impulse response. The base level or base duration adjustment feature may include and indicate a range of levels (e.g., 0 to 2 times the nominal level) to which the user may set the base level.

Each of the graphical user interfaces in FIGS. 8A-8F may further include a second input feature configured to receive a user's input to set or adjust a focus level (FIGS. 8A, 8C, 8E) or a perception level (FIGS. 8B, 8D, 8F) for the impulse response channels of the ambisonic impulse response (e.g., as described with respect to step 738 of FIG. 7C and step 758 of FIG. 7D). In various examples, the focus and perception level input features may be in the form of one-dimensional, two-dimensional, or three-dimensional representations.

For example, a one-dimensional level feature for selecting a focus level, as shown in FIG. 8A, and a perception level, as shown in FIG. 8B, may include a knob, pull-down menu, dial, text entry field, slider, or other adjustment feature for selecting or inputting the focus level (or the perception level). For example, the focus level (or perception level) input feature may be selectable to input a focus level (or perception level) that may be in different measures or scales. For example, the focus level (or perception level) may be input as a percentage increase over the base level or may be in other units, such as decibels. The focus level selection in FIG. 8A (or perception level in FIG. 8B) may further include a set of axis and/or channel selection options (e.g., radio buttons, checkboxes, etc.) that enable the user to designate which axes to apply to the focus level (or the perception level), for example, as previously described with respect to steps 732 and 734 of FIG. 7C (or steps 752 and 754 of FIG. 7D). For example, as shown in FIGS. 8A and 8B, selection features (e.g., windows) may be provided for axes or channels (e.g., X, Y, and Z axes or channels). Using each window, a user may designate each axis (or channel) as an augmented axis (or augmented channel) (e.g., by entering a +), as an attenuated axis (or attenuated channel) (e.g., by entering a −), or as neither an augmented nor attenuated channel (e.g., by leaving the window blank). In some examples, the selection feature may allow the user to select only whether an axis is augmented, with all other axes or channels treated as attenuated (or unaffected) axes or channels.

FIGS. 8C and 8D show examples of two-dimensional focus level and perception level selection features, respectively. As shown in FIG. 8C, the selection feature may be a two-dimensional window (e.g., a box) with two axes (or channels) represented as coordinates (e.g., orthogonal coordinates). The user may set or move (e.g., with a pointer) a vector in the window that sets the magnitude of the focus level (e.g., with vector length being proportional to the magnitude) and direction of the focus level. The magnitude may correspond, for example, to the focus level set in FIG. 8A. The direction may correspond to which axes are selected as augmented axes. For example, a vector that points in the positive X-axis direction would set the X-axis as an augmented axis. As another example, a vector that points at a 45-degree angle from the X-axis would set the X-axis and the Y-axis equally as augmented axes. The X and Y components of the vector may set the relative amount of focus for each axis or channel represented in the window. The input may include additional inputs (e.g., a slider bar) for other axes (e.g., the Z-axis) or channels not represented in the window to set the focus level for those other axes. While shown in FIG. 8C as a focus level setting, the same window may be applied for setting a perception level.

FIG. 8D illustrates an alternate two-dimensional input feature similar to that shown in FIG. 8C for setting a perception level. With this alternate feature, a user may change the dimension of the window (e.g., by pushing or sliding the walls with a pointer), wherein the perception levels for each axis or channel are set proportional to the width or the height that represents the axis. The window may, for example, correspond to the dimensions of a room, where extending/decreasing the width or length of the room may correspond to an increase/decrease of the perception effects (e.g., echoes) in the width (X) or length (Y) directions, respectively.

FIGS. 8E and 8F illustrate examples of a three-dimensional selection feature for selecting the focus and perception levels, respectively. The three-dimensional feature may show a perspective view of a cartesian coordinate space with X, Y, and Z axes. A user may set or move (e.g., with a pointer) a vector in the coordinate space to set the direction of the focus or perception level and the magnitude of the focus or perception level (e.g., with vector length being proportional to the magnitude). The magnitude may correspond, for example, to the focus or perception level set in FIGS. 8A and 8B, respectively. The direction may correspond to which axes (e.g., X, Y, and/or Z) are selected as augmented axes. For example, a vector that points at a 45-degree azimuth angle and a 45-degree polar angle would set the X-axis, Y-axis, and Z-axis equally as augmented axes. The vector's X, Y, and Z components may set the relative amount of focus or perception for each axis or channel represented in the window. The input may include additional inputs (not shown) for other axes or channels not represented in the window to set the focus level for those other axes or channels.

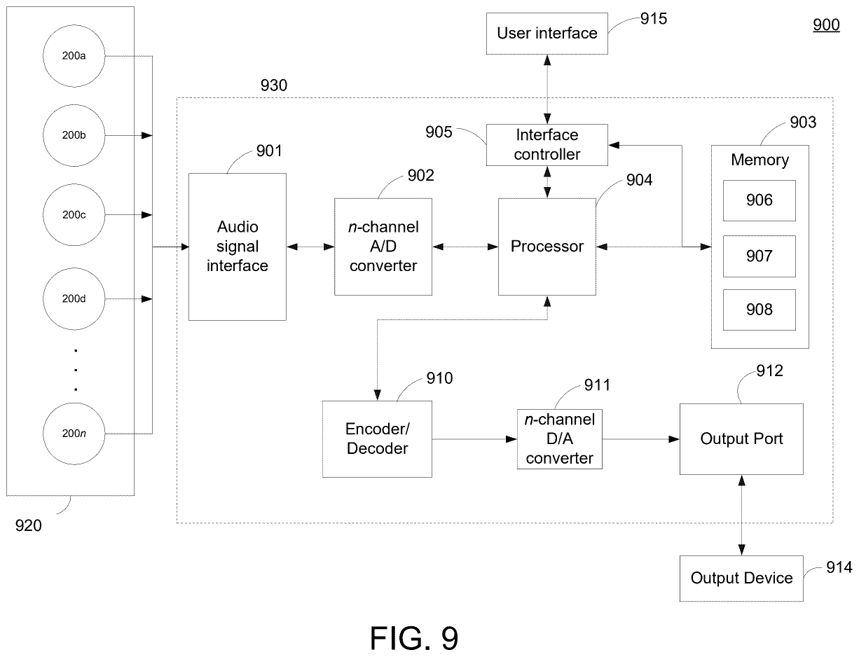

FIG. 9 illustrates an example of an ambisonic system 900 (also referred to as audio device 900) that may be used to implement one or more illustrative aspects described herein, including one or more microphones 101, 101A, 101B, 101C, 101D, and/or any other microphone arrangement described herein that includes an array 920 of microphone capsules 200a-200n. Ambisonic system 900 may include and/or be communicatively connected to a processor 904 to control the microphones'overall operation. Ambisonic system 900 may include an array 920 of microphone capsules 200a, 200b, 200c, 200d, and 200n. Ambisonic system 900 may include and/or be communicatively connected to n-channel analog-to-digital (“A/D”) converter 902. In one or more examples, n may be greater than or equal to 2, 3, 4, 5, 6, 7, 8, or 9. The number of n microphone capsules may correspond to the number of n channels of A/D converter 902 (i.e., the number of microphone capsules and the number of channels in A/D converter 902, both represented as the integer n, may be the same). Ambisonic system 900 may include and/or be communicatively connected to memory 903. Memory 903 may store software (e.g., executed by processor 904), including operating system 906 for controlling the overall operation of ambisonic system 900 and/or control logic 907 for instructing ambisonic system 900 to perform aspects described herein. The functionality of the control logic 907 may refer to operations or decisions made automatically based on rules coded into the control logic 907, made manually by a user providing input into the system, and/or a combination of automatic processing based on user input (e.g., queries, data updates, user-selected modes, a list of input devices previously setup with the software application, etc.). Memory 903 may store data used to perform one or more aspects described herein, including in a database 908. The memory may store other data. For example, where the memory 903 is part of, for example, ambisonic system 900, the memory may store its operating system and/or the software application that performs aspects described herein, user preferences such as preferred modes, a list of input devices (such as microphones 101, 101A, 101B, or 101C, 101D and/or microphone capsules 200a-200n, among others) previously setup with the software application, communication protocol settings, and/or data supporting any other functionality of the microphones.

One or more aspects may be embodied in computer-usable or readable data and/or computer-executable instructions, such as in one or more program modules, executed by one or more computers (e.g., 302, 304, 904) or other devices as described herein, such as microphones 101, 101A, 101B, 101C, and/or 101D. Generally, program modules include routines, programs, objects, components, data structures, etc., that perform particular tasks or implement particular abstract data types when executed by a processor in a computer or other device. The modules may be written in a source code programming language that is subsequently compiled for execution or in a scripting language such as (but not limited to) Python, Perl, PHP, Ruby, JavaScript, and the like. The computer-executable instructions may be stored on a computer-readable medium such as a nonvolatile storage device. Any suitable computer-readable storage media, including hard disks, CD-ROMs, optical storage devices, magnetic storage devices, solid-state storage devices, and/or any combination thereof, may be utilized. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, different functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer-executable instructions and computer-usable data described herein.

The n-channel A/D converter 902, memory 903, processor 904, n-channel digital-to-audio (“D/A”) converter 911, and output port 912 may be implemented in microphone 101 and/or any one or more of devices 302, 304, and/or 306, as well as (or alternatively) in one or more additional devices (not shown). Aspects described herein may be operational with numerous other general-purpose and/or special-purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set-top boxes, programmable consumer electronics, network personal computers (PCs), minicomputers, mainframe computers, supercomputers configured to run online application programming interfaces (APIs), distributed computing environments that include any of the above systems or devices, and the like. Aspects of ambisonic system 900 may be implemented as embedded software running in, for example, processor 904. Aspects of ambisonic system 900 may be implemented as a signal processor, such as a hardware DSP module, a real-time software processor, an offline software processor, or a software plug-in (including VST, AU, and AAX formats). The ambisonic system 900 may be compatible with software or plugins for any number of video communications or streaming platforms.

Microphone capsules 200a-200n may be configured to receive acoustic signals emanating from various directions in an acoustic environment. The microphone capsules may capture a set of audio signals in A-format. The set of audio signals may vary widely in duration (e.g., from less than one second to more than 1000 seconds). The microphone capsules may provide a set of A-format audio signals to an external device (e.g., 302, 304, 901, 902, 904). Onboard processing (e.g., system 900, processor 904) of the ambisonic microphone may encode the set of A-format audio signals to B-format, C-format (or Ambisonic UHJ, such as nested multi-channel output formats), D-format (such as 3.1, 5.1, 5.1.n 7.1, 7.1.n and/or other surround sound formats, including custom speaker array formats and other formats with pre-encoded channels), G-format, mono, stereo, and/or to a binaural audio format for headphone listening (described further below with respect to FIG. 9). Processor 904 may render the A-format, B-format, C-format, D-format, and/or G-format audio signals (e.g., impulse response signals) for use in an external device. Ambisonic system 900 may provide the rendered set of mono, stereo, binaural, B-format, C-format, D-format, and/or G-format audio signals to an external device.

As shown in FIG. 9, the ambisonic system 900 (also referred to as the audio device 900) may include a converter module 930 and/or be communicatively connected to the converter module 930. Converter module 930 may include controller 901. The device controller 901 may facilitate interaction from microphone capsules 200a-200n to various components of the converter module 930. Analog and/or digital audio may be transmitted from the microphone array 920 to the device controller 901. Digital data may be transmitted bidirectionally (from the microphone array 920 to the device controller 901 and/or from the device controller 901 to the microphone array 920). The microphone array 920 may include, for example, one or more universal serial bus (USB) connectors, one or more XLR connectors, one or more power connectors, and/or any other type of data and/or power connectors suitable for transporting signals such as power, digital data (including digital audio signals), and/or analog audio signals to and from the microphone array 920. Where the connection is wired, the device controller 901 may further comprise a data interface (not shown) for communicating with the microphone array 920. For example, the data interface may include a USB interface and/or an XLR interface. While several wired connections are discussed between the device controller 901 and the microphone array 920, other wired or wireless connections may be used. For example, the connection between the device controller 901 and the microphone array 920 may instead be a wireless connection, such as a Wi-Fi connection or other proprietary wireless connection protocols, a Bluetooth connection, a near-field connection (NFC), and/or an infrared connection. Where the connection is wireless, the device controller 901 and microphone array 920 may include a wireless communications interface.

In operation, device controller 901 may receive a set of A-format audio signals captured with microphone capsules 200a-200n. Device controller 901 may route the set of A-format audio signals to A/D converter 902, which may provide a set of digital A-format audio signals (e.g., impulse response signals) to processor 904 for further processing. Processor 904 may provide a digital set of A-format audio signals (e.g., audio signals convoluted with the impulse response signals) to D/A converter 911 for output via output port 912 to an output device 914. The number of n channels of D/A converter 911 may correspond to the number of n channels of the A/D converter and/or to the number of n microphone capsules (i.e., the number of channels in D/A converter 911, represented as the integer n, may be the same as the number of channels in A/D converter 902 and/or same as the number of microphone capsules). Output device 914 may be any of devices 302, 304, and/or other devices such as a mixing console, recording console, headphones, earphones, etc.

The converter module 930 may include an encoder/decoder 910. Encoder 910 may be configured to encode (or convert) the set of digital A-format audio signals to a set of B-format audio signals. Encode 910 may be configured to decode (or render) the set of B-format audio signals to D/A converter 911 and via port 912 for use in output device 914. Encoder 910 may employ any number of time-domain processing techniques when performing A-format to B-format encoding of the set of audio signals. Encoder 910 and/or processor 904 may employ any number of purely time-domain processing techniques when performing A-format to B-format encoding of the set of audio signals. Encoder 910 and/or processor 904 might not perform a Fast Fourier Transformation of the set of A-format audio signals before encoding to B-format. Instead, encoder 910 and/or processor 904 may analyze one or more waveforms of the set of audio signals. Encoder 910 and/or processor 904 might not convert the set of audio signals into spectral components and might not analyze those spectral components of the set of audio signals.

Encoder/decoder 910 may be configured to decode the set of B-format audio signals to a set of D-format audio signals. Converter module 930 may include an interface controller 905 communicatively connected to a user interface 915. The interface controller 905 may facilitate communication between a user interface 915 and the converter module 930. For example, interface controller 905 may receive user indications and/or queries from user interface 915 and provide the indications and/or queries to the converter module for further actions described herein. The user interface 915 may comprise, for example, a display and a user input device (e.g., capacitive-touch interface) that a user may control via touch or a graphical user interface. A companion software application (not shown) installed on device 102 and/or device 104 may provide the user interface 915 and may perform some or all of the processing and decoding of the audio signals described herein.

The interface 915 may function in concert with some or all of the hardware and/or software components described herein to help simplify the setup and workflow of capturing spatial audio with the microphone array 920 and providing it to a consumer. The user interface 915 may present a user with several audio capture and conversion options. For example, interface 915 may provide the user with options to output captured audio signals in mono, stereo, binaural, A-format, B-format, C-format, D-format, and/or G-format audio standards to an external device. Interface 915 may provide the user with other pre- and/or post-recording processing options, such as filtering, equalization, compression, and steerable virtual microphones with independent position/localization, gain adjustments, etc. Interface 915 may provide the user with a graphical representation of an acoustic sound field and may allow the user to create any number of virtual microphones and manipulate the polarity of said virtual microphones. Interface 915 may include a video feed window to allow a user to monitor the synchronization of incoming audio signals to either live or pre-recorded video data. Interface 915 may provide the graphical user interfaces shown in FIGS. 8A-8F to provide the user with options for entering augmentation parameters, such as focus and perception levels.

Any of the circuitry in FIG. 9 may be implemented, for example, as a programmable gate array (PGA), as a MOS integrated circuit (IC) chip, an application-specific integrated circuit (ASIC), a complex programmable logic device (CPLD), a field-programmable gate array (FPGA) chip, or an analog electrical circuit. The ASIC could contain a transistor, such as a FET. Any operations described herein may be implemented with hardware, software, and/or a combination thereof.

A number of device configurations may perform the aspects described herein. For example, a user may connect, for example, microphones 101, 101A, 101B, 101C, or 101D and/or any other microphone described herein to devices 102, 104, and/or other devices operating a software application capable of performing the operations described herein. In another example, the aspects described herein can be performed by a smartphone, desktop computer, laptop computer, and/or other devices having an internal microphone and a software application capable of performing the operations described herein.

In the foregoing specification, the present disclosure has been described with reference to specific exemplary examples thereof. Although the invention has been described in terms of a preferred example, those skilled in the art will recognize that various modifications, examples, or variations of the invention can be practiced within the spirit and scope of the invention as set forth in the appended claims. Therefore, the specification and drawings are to be regarded in an illustrated rather than restrictive sense. Accordingly, it is not intended that embodiments be limited except as may be necessary in view of the appended claims.

What is claimed is:

1. A method comprising:
receiving an ambisonic impulse response, wherein the ambisonic impulse response comprises a plurality of impulse response channels corresponding to a plurality of audio channels of an ambisonic audio signal, respectively;
receiving an augmentation direction and an augmentation parameter;
selecting, based on the augmentation direction, a subset of the plurality of impulse response channels;
augmenting, based on the augmentation parameter, the subset of the plurality of impulse response channels to generate a modified ambisonic impulse response;
filtering the ambisonic audio signal with the modified ambisonic impulse response to generate an augmented ambisonic audio signal having augmented reverberation effects; and
storing the augmented ambisonic audio signal with the augmented reverberation effects to a memory.

2. The method of claim 1, further comprises:
selecting a second subset of the plurality of impulse response channels not in the subset; and
attenuating, based on the augmentation parameter, each impulse response channel of the second subset.

3. The method of claim 1, wherein the augmentation parameter comprises:
a focus level corresponding to an impulse response amplitude adjustment; or
a perception level corresponding to an impulse response duration adjustment.

4. The method of claim 3, wherein the augmenting of the subset comprises:
increasing, based on the focus level, a relative peak amplitude or a wet/dry percentage of each impulse response channel of the subset.

5. The method of claim 4, further comprising:
decreasing, based on the focus level, the relative peak amplitude or the wet/dry percentage of one or more impulse response channels of the plurality of impulse response channels not in the subset.

6. The method of claim 3, wherein the augmenting of the subset comprises:
increasing, based on the perception level, a pre-delay or a tail length of each impulse response channel of the subset.

7. The method of claim 6, further comprising:
decreasing, based on the perception level, the pre-delay or the tail length of one or more impulse response channels of the plurality of impulse response channels not in the subset.

8. The method of claim 1, wherein the filtering comprises:
convolving the plurality of audio channels with the corresponding plurality of impulse response channels of the modified ambisonic impulse response, respectively.

9. The method of claim 1, further comprising:
receiving a monophonic audio signal and a steered direction;
mapping, based on the steered direction, the monophonic audio signal to the plurality of audio channels to generate the ambisonic audio signal; and
generating, from the augmented ambisonic audio signal, an augmented monophonic audio signal with the augmented reverberation effects scaled according to the steered direction.

10. An apparatus comprising:
a processor; and
one or more memories having stored therein computer-executable instructions that, when executed by the processor, cause the apparatus to:
receive an ambisonic impulse response, wherein the ambisonic impulse response comprises a plurality of impulse response channels, corresponding to a plurality of audio channels of an ambisonic audio signal, respectively;
receive an augmentation direction and an augmentation parameter;
select, based on the augmentation direction, a subset of the plurality of impulse response channels;
augment, based on the augmentation parameter, the subset of the plurality of impulse response channels to generate a modified ambisonic impulse response; and
store the modified ambisonic impulse response to the one or more memories.

11. The apparatus of claim 10, wherein the computer-executable instructions, when executed by the processor, cause the apparatus to:
filter the ambisonic audio signal with the modified ambisonic impulse response to generate an augmented ambisonic audio signal having augmented reverberation effects; and
store the ambisonic audio signal with the augmented reverberation effects to the one or more memories.

12. The apparatus of claim 11, wherein the computer-executable instructions, when executed by the processor, cause the apparatus to:
select a second subset of the plurality of impulse response channels not in the subset; and
attenuate, based on the augmentation parameter, each impulse response channel of the second subset.

13. The apparatus of claim 11, wherein the augmentation parameter comprises:
a focus level corresponding to an impulse response amplitude adjustment; or
a perception level corresponding to an impulse response duration adjustment.

14. The apparatus of claim 13, wherein, to augment the subset, the computer-executable instructions, when executed by the processor, cause the apparatus to:
increase, based on the focus level, a relative peak amplitude or a wet/dry percentage of each impulse response channel of the subset.

15. The apparatus of claim 13, wherein, to augment the subset, the computer-executable instructions, when executed by the processor, cause the apparatus to:
increase, based on the perception level, a pre-delay or a tail length of each impulse response channel of the subset.

16. The apparatus of claim 15, wherein the computer-executable instructions, when executed by the processor, cause the apparatus to:
decrease, based on the perception level, the pre-delay or the tail length of one or more impulse response channels of the plurality of impulse response channels not in the subset.

17. The apparatus of claim 16, wherein, to filter the ambisonic audio signal, the computer-executable instructions, when executed by the processor, cause the apparatus to:
convolve the plurality of audio channels with the corresponding plurality of impulse response channels of the modified ambisonic impulse response, respectively.

18. The apparatus of claim 10, wherein the computer-executable instructions, when executed
by the processor, cause the apparatus to:
receive a monophonic audio signal and a steered direction;
map, based on the steered direction, the modified ambisonic impulse response to a monophonic impulse response with augmented reverberation effects scaled according to the steered direction; and
filter the monophonic audio signal with the monophonic impulse response to generate, an augmented monophonic audio signal.

19. An ambisonic audio system comprising:
a user input interface circuit;
a processor; and
one or more memories having stored therein computer-executable instructions that, when executed by the processor, cause the processor to:
retrieve, from the memory, an ambisonic impulse response comprising X, Y, Z, and W impulse response channels;
receive, via the user input interface circuit, an augmentation parameter and a first subset of channels selected from the X, Y, and Z impulse response channels;
designate, as a second subset of channels, the X, Y, and Z impulse response channels that are not in the first subset of channels;
modify the ambisonic impulse response by, based on the augmentation parameter: augmenting the first subset of channels and attenuating the second subset of channels; and
store the modified ambisonic impulse response to the one or more memories.

20. The ambisonic audio system of claim 19, wherein, to modify the ambisonic impulse response, the computer-executable instructions, when executed by the processor, cause the processor to:
adjust, based on a focus level in the augmentation parameter, a relative peak amplitude and a wet/dry percentage of the first subset of channels and the second subset of channels; or
adjust, based on a perception level in the augmentation parameter, a pre-delay or a tail length of the first subset of channels and the second subset of channels.
